(19) United States
(12) Patent Application Publication
(10) Pub. No.: US 2009/0190641 A1
(43) Pub. Date: Jul. 30, 2009

(54) METHODS AND DEVICES FOR PROCESSING SIGNALS TRANSMITTED VIA COMMUNICATION SYSTEM

(76) Inventor: Yen-Wen Yang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/020,582

(22) Filed: Jan. 28, 2008

(51) Int. Cl. H04B 17/00

(52) U.S. Cl. 375/224

(57) ABSTRACT

A method for processing signals transmitted via a communication system includes: measuring a first parameter associated with a signal power of a first frequency band of a received signal; measuring a second parameter associated with a signal power of a second frequency band of the received signal, wherein the first frequency band and the second frequency band are not overlapped; comparing the first parameter with the second parameter to generate a comparison result; and detecting whether adjacent channel interference (ACI) exists in the communication system according to the comparison result to generate a detection result.

### BACKGROUND OF THE INVENTION

1. Field of the Invention

The present invention relates to processing signals transmitted via a communication system, and more particularly, to methods and devices for detection of adjacent channel interference (ACI) in a Digital Video Broadcasting (DVB) system.

2. Description of the Prior Art

Due to sharing the same frequency band as conventional television broadcasting systems such as the National Television System Committee (NTSC) system, the Digital Video Broadcasting (DVB) system often encounters the problem of adjacent channel interference (ACI). To counter this effect, ACI filters are often used in the receiver of the DVB system; however, some unwelcome effect is also introduced at the same time.

Please refer to FIG. 1. FIG. 1 illustrates the frequency domain graph of signals in a prior art DVB receiver. The curve 110 represents a DVB signal, having a bandwidth of 2*f1, while the curve 112 and the curve 114 are ACI signals; additionally, the curve 116 represents a frequency response of an ACI filter. As shown in FIG. 1, the DVB signal will have a distortion after the operation of the ACI filter due to imperfect characteristics of the filter (e.g. the roll-off rate of the ACI filter is not sharp enough), even though the ACI signals can be eliminated. Since the occurrence of the ACI signals in the DVB system is volatile, utilization of the ACI filter may degrade the system performance when ACI signals are absent. Therefore, a novel mechanism of detecting the ACI signals to control the operation of the ACI filter according to the existence of the ACI signals should be devised to thereby improve the system performance.

### SUMMARY OF THE INVENTION

It is therefore one of the objectives of the claimed invention to provide methods and devices for processing signals transmitted via a communication system to solve the above-mentioned problems.

According to one embodiment of the claimed invention, a method for processing signals transmitted via a communication system is disclosed. The method comprises: measuring a first parameter associated with a signal power of a first frequency band of a received signal; measuring a second parameter associated with a signal power of a second frequency band of the received signal, wherein the first frequency band and the second frequency band are not overlapped; comparing the first parameter with the second parameter to generate a comparison result; and detecting whether adjacent channel interference (ACI) exists in the communication system according to the comparison result in order to generate a detection result.

As well as the above-mentioned method, a device for processing signals transmitted via a communication system is further disclosed according to one embodiment of the claimed invention. The device comprises: a first evaluation unit, for measuring a first parameter associated with a signal power of a first frequency band of a received signal; a second evaluation unit, for measuring a second energy level of a second frequency band of the received signal, wherein the first frequency band and the second frequency band are not overlapped; a comparator, coupled to the first evaluation circuit and the second evaluation circuit, for comparing the first parameter with the second parameter to generate a comparison result; and a decision unit, coupled to the comparator, for detecting whether ACI exists in the communication system according to the comparison result in order to generate a detection result.

According to yet another embodiment of the claimed invention, a device for processing signals transmitted via a communication system is provided. The device includes: a decision logic, for detecting whether adjacent channel interference (ACI) exists in the communication system to generate a detection result in a frequency domain; and a controller, coupled to the decision unit, for generating an output signal by selectively enabling or disabling an ACI filtering operation for filtering out the ACI of a received signal according to the detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a frequency domain graph of signals in a prior art Digital Video Broadcasting (DVB) receiver.

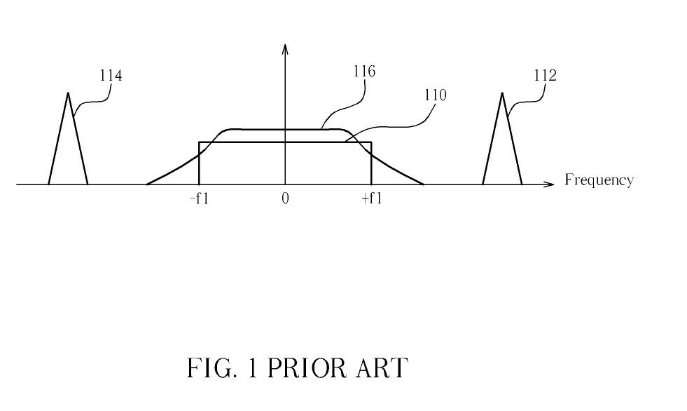

FIG. 2 illustrates a block diagram of a signal processing circuit for detecting adjacent channel interference (ACI) in a DVB receiver according to one embodiment of the invention.

FIG. 3 illustrates outputs of an FFT unit shown in FIG. 2.

FIG. 4 illustrates a block diagram of a signal processing circuit for detecting the ACI in a DVB receiver according to a second embodiment of the invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

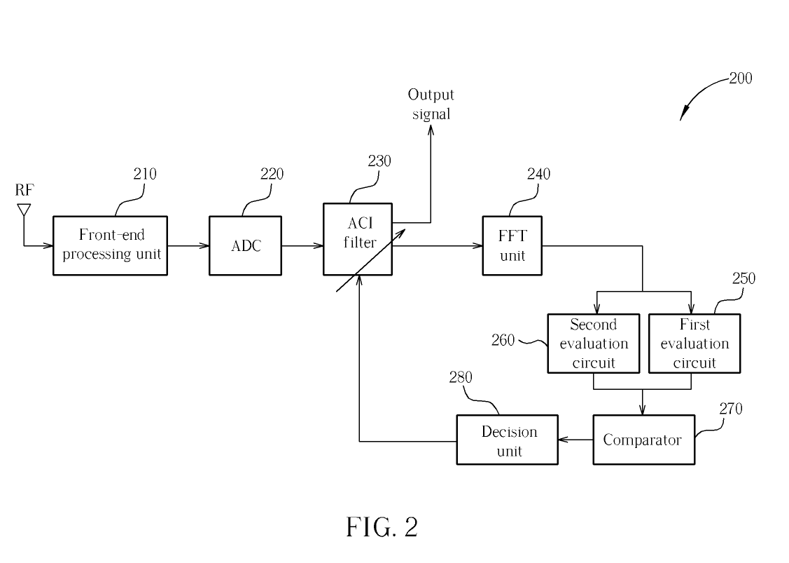

Please refer to FIG. 2. FIG. 2 illustrates a block diagram of a signal processing circuit for detecting adjacent channel interference (ACI) in a Digital Video Broadcasting (DVB) receiver according to a first embodiment of the invention. The signal processing circuit 200 comprises a first evaluation circuit 250, a second evaluation circuit 260, a comparator 270, and a decision unit 280. As shown in FIG. 2, the received DVB signal will first be converted to a baseband signal by the front-end processing unit 210 (through quadrature-mixing and low-pass filtering, which are well known in the art). The baseband signal is then sampled and digitized using an analog-to-digital converter (ADC) 220; after that, the digitized signal is inputted into a controllable ACI filter 230. In this exemplary embodiment, the controllable ACI filter 230 is initially turned off and is not turned on until the ACI is detected. Since the ACI filter is disabled, the signal bypassed by the controllable ACI filter 230 and then is converted to the frequency domain by the Fast Fourier Transform (FFT) unit 240. Since the DVB system adopts the Orthogonal Frequency Division Multiplexing (OFDM) technique, the FFT algorithm has to be used to convert the received DVB signal to the frequency domain. That is, the received DVB signal includes a plurality of OFDM symbols, and each OFDM symbol has information transmitted via a plurality of orthogonal subcarriers. Therefore, the typical OFDM signals have to be detected and processed using the FFT algorithm.

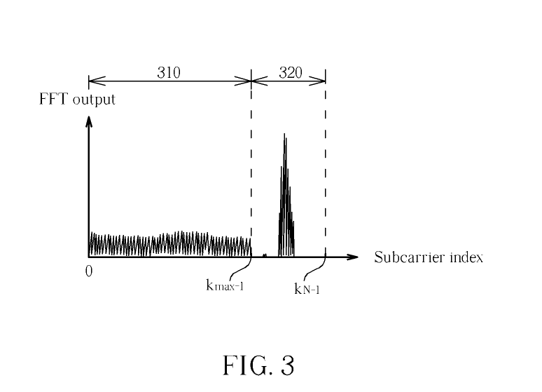

Please refer to FIG. 3. FIG. 3 illustrates the output of the FFT unit 240 shown in FIG. 2. As shown in FIG. 3, the curve 310 shows a DVB signal in a signal band (in-band signal) in the frequency domain and the curve 320 represents an ACI signal in a DVB guard band in the frequency domain. That is, the range of curve 310 having the subcarrier indexes 0-kₘₐₓ included therein represents a frequency band of the whole DVB signal (i.e., the signal band). The other range of the curve 320 delimited from the subcarrier indexes kₘₐₓ and K_{N-1} represents a guard band of the DVB signal (please note that Kₘₐₓ represents the maximum subcarrier index, and N represents FFT sampling points), where there is not supposed to be any signal located. It should be noted that the signal band of the DVB signal and the guard band of the DVB signal are adjacent to each other but not overlapped. As the technique of OFDM is well known to those skilled in the pertinent art, related details are not repeated here for the sake of brevity.

To detect the ACI signal, measuring the signal power of the received signal is an efficient manner to determine whether the ACI occurs or not. As known to those skilled in the art, in the frequency domain, the greater is the absolute value of a signal component at a specific frequency, the stronger the signal power of the signal component at the specific frequency is. In general, the signal power is estimated by computing a root mean square of a plurality of signal components over a frequency band.

Hence, for detecting the ACI occurrence, the first evaluation circuit 250 and the second evaluation circuit 260 will measure the parameter associated with a signal power of the guard band of a received signal and measure the parameter associated with a signal power of the signal band of a received signal respectively. In this embodiment, the method of measuring the parameter associated with a signal power is directly summing the absolute value of the output of the FFT unit 240, as follows:

A_{DVB-T}=Σ_{k=0˜k max-1}|Rₖ| (1)

A_{ACI}=Σ_{k=K max˜N-1}|Rₖ| (2)

where,

A_{DVB-T}: parameter associated with a signal power of the received DVB signal in the signal band;

A_{ACI}: parameter associated with a signal power of the ACI signal in the guard band;

k: subcarrier index;

Kₘₐₓ: maximum subcarrier index (for 2K mode, Kₘₐₓ=1705; for 8K mode, Kₘₐₓ=6817);

N: FFT sampling points (for 2K mode, N=2048; for 8K mode, N=8192); and

Rₖ: k^{th} FFT output.

Since the FFT output is a complex number, the absolute value of the k^{th} FFT output (i.e., Rₖ) can be directly obtained through computing the square root of Re(Rₖ) and Im(Rₖ) i.e., {square root over ((Re(Rₖ)²+(Im(Rₖ)²)}. That is to say, the absolute value of the k^{th} FFT output, Rₖ, is the square root of (Re(Rₖ))²+(Im(Rₖ))² where Re(Rₖ) and Im(Rₖ) respectively represent the real part and imaginary part of Rₖ.

The comparator 270 then compares the two parameters A_{DVB-T} and A_{ACI} to generate a comparison result CR by estimating a ratio of A_{ACI} to A_{DVB-T}, as below:

CR=A_{ACI}/A_{DVB-T} (3)

The decision unit 280 can detect whether the ACI exists according to the comparison result CR to generate a detection result. The decision rule is as follows:

If A_{ACI}/A_{DVB-T}≦ACI_thrd, then ACI is absent;

If A_{ACI}/A_{DVB-T}>ACI_thrd, then ACI exists.

If the comparison result CR is not greater than a predetermined threshold value (e.g. ACI_thrd), the decision unit 280 will accordingly determine the absence of the ACI and generate a detection signal to the controllable ACI filter 230 for the purpose of turning off the ACI filter 230; otherwise, if the comparison result is greater than the predetermined threshold value, the decision unit 280 will determine the existence of the ACI and therefore generate a decision signal accordingly to the controllable ACI filter 230 for turning on the ACI filter 230. Through the detection signal generated by the decision unit 280, an output signal is outputted from the ACI filter 230 after selectively enabling or disabling an ACI filtering operation for filtering out the ACI within the received signal.

By using the ACI detection mechanism described above, this exemplary embodiment can provide an improved way to control the ACI filtering operation according to the existence of the ACI, and therefore can provide better signal performance. It should be noted that the present invention is not restricted to be employed in the DVB system. For example, it can also apply to any communication system that uses the OFDM technique.

Please note that the circuit configuration shown in FIG. 2 is for illustrative purposes only, and is not a limitation of the invention. In addition, in the first exemplary embodiments, the method of measuring the parameter associated with a signal power is not restricted to the summation of the absolute value of FFT output mentioned above. Any method that can derive the parameter associated with a signal power of the signal (such as summation of the square of the FFT output) obeys the spirit of the invention, and falls within the scope of the invention.

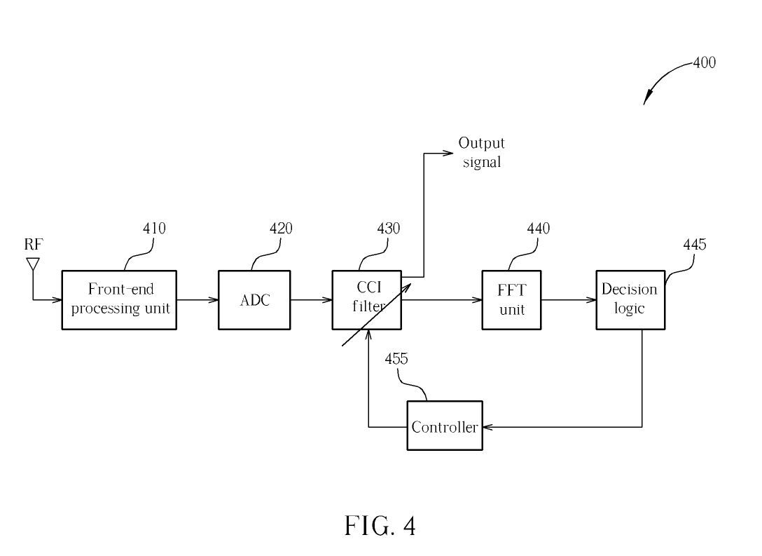

Please refer to FIG. 4. FIG. 4 illustrates a block diagram of a signal processing circuit for detecting an ACI in a DVB receiver according to a second embodiment of the invention. The signal processing circuit 400 comprises a front-end processing unit 410, an ADC 420, an ACI filter 430, a FFT unit 440, a decision logic 445, and a controller 455. Wherein the decision logic 445 is configured for detecting whether ACI exists in the DVB communication system and generates a detection result in a frequency domain. Then, the controller 455 selectively enables or disables the controllable ACI filter 430 according to the detection result. In other words, an output signal is generated from the ACI filter 430 by means of selectively enabling or disabling an ACI filtering operation for filtering out the ACI of the received signal in the guard band and therefore avoid the information signal of the signal band (i.e., in-band) being interfered. The decision logic 445 in FIG. 4 can be implemented using the circuit components shown in FIG. 2, such as functional blocks 250, 260, and 270. However, any circuit configuration capable of detecting the ACI in a frequency domain and then selectively enabling or disabling the ACI filtering operation (i.e., the controllable ACI filter 430) according to the ACI detection result can be employed in the decision logic 445 and the controller 455. These alternative designs also obey the spirit of the present invention, and fall in the scope of the present invention. Since other operation of the signal processing circuit 400 in FIG. 4 is approximately the same with that of the signal processing circuit 200 in FIG. 2, the related detail is not repeated here for brevity.

Furthermore, the magnitude of the predetermined threshold value ACI_thrd is not meant to be a limitation of the present invention. Any method that can derive the approximate value of a signal power of the signal (such as summation of the square of the FFT output) and/or calculate a ratio between the DVB signal and the ACI signal obeys the spirit of the invention falls within the scope of the invention.

Those skilled in the art will readily observe that numerous modifications and alterations of the device and method may be made while retaining the teachings of the invention.

What is claimed is:

1. A method for processing signals transmitted via a communication system, comprising:
measuring a first parameter associated with a signal power of a first frequency band of a received signal;
measuring a second parameter associated with a signal power of a second frequency band of the received signal, wherein the first frequency band and the second frequency band are not overlapped;
comparing the first parameter with the second parameter to generate a comparison result; and
detecting whether adjacent channel interference (ACI) exists in the communication system according to the comparison result to generate a detection result.

2. The method of claim 1, wherein the communication system is a digital television system.

3. The method of claim 2, wherein the digital television system complies with a digital video broadcasting (DVB) standard.

4. The method of claim 1, wherein the communication system is an Orthogonal Frequency-Division Multiplexing (OFDM) system.

5. The method of claim 1, wherein one of the first frequency band and the second frequency band is a signal band of the communication system, and the other of the first frequency band and the second frequency band is a guard band of the communication system.

6. The method of claim 5, wherein the guard band is immediately adjacent to the signal band.

7. The method of claim 1, further comprising:
generating an output signal by selectively enabling or disabling an ACI filtering operation for filtering out the ACI of the received signal according to the detection result.

8. The method of claim 1, wherein comparing the first parameter with the second parameter to generate the comparison result further comprises:
determining a ratio between the first parameter and the second parameter; and
comparing the ratio with a predetermined threshold value to generate the comparison result.

9. A device for processing signals transmitted via a communication system, comprising:
a first evaluation unit, for measuring a first parameter associated with a signal power of a first frequency band of a received signal;
a second evaluation unit, for measuring a second parameter associated with a signal power of a second frequency band of the received signal, wherein the first frequency band and the second frequency band are not overlapped;
a comparator, coupled to the first evaluation circuit and the second evaluation circuit, for comparing the first parameter with the second parameter to generate a comparison result; and
a decision unit, coupled to the comparator, for detecting whether adjacent channel interference (ACI) exists in the communication system according to the comparison result to generate a detection result.

10. The device of claim 9, wherein the communication system is a digital television system.

11. The device of claim 10, wherein the communication system complies with a digital video broadcasting (DVB) standard.

12. The device of claim 9, wherein the communication system is an Orthogonal Frequency-Division Multiplexing (OFDM) system.

13. The device of claim 9, wherein one of the first frequency band and the second frequency band is a signal band of the communication system, and the other of the first frequency band and the second frequency band is a guard band of the communication system.

14. The device of claim 13, wherein the guard band is immediately adjacent to the signal band.

15. The device of claim 9, further comprising:
an ACI filter, coupled to the decision unit, for generating an output signal by selectively filtering out the ACI of the received signal according to the detection result.

16. The device of claim 9, wherein the comparator generates the comparison result by determining a ratio between the first parameter and the second parameter, and comparing the ratio with a predetermined threshold value to generate the comparison result.

17. A device for processing signals transmitted via a communication system, comprising:
a decision logic, for detecting whether adjacent channel interference (ACI) exists in the communication system to generate a detection result in a frequency domain; and
a controller, coupled to the decision unit, for generating an output signal by selectively enabling or disabling a ACI filtering operation for filtering out the ACI of a received signal according to the detection result.

18. The device of claim 17, wherein the communication system is a digital television system.

19. The device of claim 18, wherein the communication system complies with a digital video broadcasting (DVB) standard.

20. The device of claim 17, wherein the communication system is an Orthogonal Frequency-Division Multiplexing (OFDM) system.
